(19) United States
(12) Patent Application Publication
(10) Pub. No.: US 2016/0283099 A1
(43) Pub. Date: Sep. 29, 2016

(54) INTERACTIVE CONTENT TIMELINE PLATFORM

(71) Applicant: CaptureLife, Inc., Haymarket, VA (US)

(72) Inventors: Scott DeFusco, Haymarket, VA (US); Jeff Eckerle, Eagan, MN (US)

(21) Appl. No.: 15/080,353

(22) Filed: Mar. 24, 2016

Related U.S. Application Data
(60) Provisional application No. 62/137,295, filed on Mar. 24, 2015.

(51) Int. Cl. G06F 3/0484; G06Q 30/06; H04L 29/06

(52) U.S. Cl. CPC G06F 3/04847; H04L 65/403; G06Q 30/0613; G06Q 30/0641

(57) ABSTRACT

A system includes a database to store user personal digital content and timelines, a communication mechanism to couple to third party sources of other digital content and to the database associated with the timelines, and a user interface mechanism to provide a timeline based view of the personal and other digital content, wherein the digital content is arranged in stories having a time represented by at least one of the digital content in each story and dispersed along and positionally correlated to a user adjustable time scale of the view.

### RELATED APPLICATION

This application claims priority to U.S. Provisional Application Ser. No. 62/137,295 (entitled Interactive Content Timeline Platform, filed Mar. 24, 2015) which is incorporated herein by reference.

### BACKGROUND

Photos are currently managed by users in an ad hoc manner. Some users simply store photos on their phones and may back them up to one or more directories on a computer. Others may use cloud based photo storage services. It can be difficult to manage and find photos regardless of the methods currently used to store them. The experience of purchasing photos is also accomplished in an ad hoc manner, often in a manual process outside of the system or applications where a user stores and views their photos.

### SUMMARY

A system includes a database to store user personal digital content and timelines, a communication mechanism to couple to third party sources of other digital content and to the database associated with the timelines, and a user interface mechanism to provide a timeline based view of the personal and other digital content, wherein the digital content is arranged in stories having a time represented by at least one of the digital content in each story and dispersed along and positionally correlated to a user adjustable time scale of the view.

A method includes displaying a plurality of temporally identified stories comprising digital content on a display device, wherein the stories are spatially separated commensurate with a visible time scale, receiving input from a user to manipulate the time scale, and modifying the position and visibility of stories as represented by at least one image of the digital content of each story.

### BRIEF DESCRIPTION OF THE DRAWINGS

FIG. 1 is a flow diagram illustrating a method for consumers and professionals to utilize an interactive content timeline platform according to an example embodiment.

FIG. 2A is a block diagram of a system for the interactive content timeline platform, according to an example embodiment.

FIG. 2B is a block diagram of a system for the interactive content timeline platform, according to an example embodiment.

FIGS. 3A, 3B, 3C, 4A, 4B, 5, 6A, 6B, 7A, 7B, 7C, 8A, 8B, 9A, and 9B are screen shots of user interfaces illustrating various features of an interactive content timeline platform according to example embodiments.

FIG. 10 is a block schematic diagram of a computer architecture for various devices and system to implement example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media or computer readable storage device such as one or more memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

An interactive content timeline platform provides a way for an individual to upload personal content, such as photos and videos, to the cloud and purchase content published by content professionals, all integrated and organized into a personal interactive content timeline. The individual can browse and shop professional private or public content timelines that may have content of interest. Professional content can be purchased from any mobile or computer device and be immediately incorporated into the individual's personal timeline. The timeline provides a visualization that incorporates the elements of space between content collections based on dates; color categories for identifying specific types of content; and, the ability to pan forward and backward in time or zoom in and out of timescale.

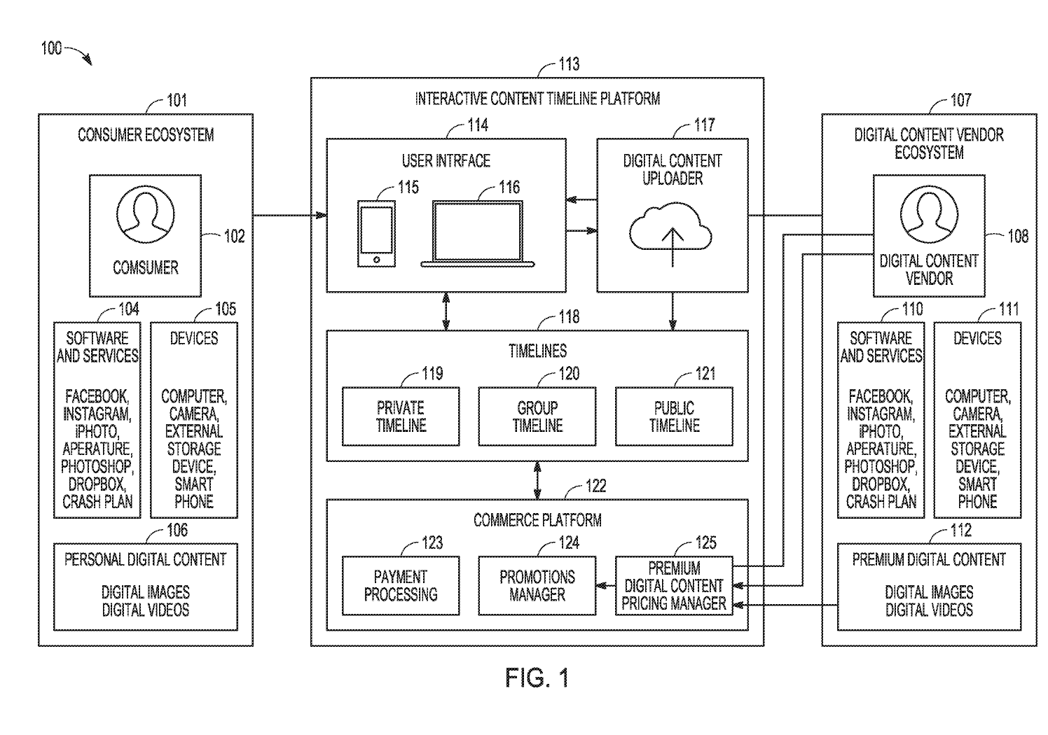

FIG. 1 is a block diagram of an interconnected system 100. An interactive content timeline platform 113 has a workflow indicated by various arrows that includes, but is not limited to a consumer ecosystem 101 that includes consumers 102 and a digital content vendor ecosystem 107 that includes vendors 108. Consumers 102 correspond to devices that people use to interact with the interactive content timeline platform 113 to upload, store, organize and browse their personal digital content 106. Consumers 102 interact with personal software and services 104 and devices 105 in consumer ecosystem 101 that relate to their personal digital content 106. Software and services 104 may comprise applications or services that are installed on a consumer's device or peripheral 105 or accessible through a network. Software and services 104 can include, but are not limited to: Google, Facebook, Apple, Dropbox, Crashplan, Carbonite, iPhoto, Photoshop, Shutterfly, or any combination thereof. Devices 105 can include, but are not limited to: computers, smart phones, cameras, tablets, recorders, storage devices, or any combination thereof. A consumer 102 can have personal digital content 106 that can be stored on devices 105 and managed with software and services 104. Personal digital content 106 can include image files, video files, and document files. These personal digital content 106 files can be referred to with file type terms that are commonly used by those of ordinary skill in the relevant arts, such as JPEG, RAW, PNG, MOV, WMV, MP4, and other terms. It will be understood by those of ordinary skill that those terms used herein are interchangeable, and any file type may be used.

The interactive content timeline platform 113 ecosystem also comprises digital content vendors 108. Digital content vendors 108 are devices used by people, working for themselves, a company, or an organization, that produce digital content that is viewed and/or purchased by one or more consumers 102. Digital content vendors 108 have similar content sources 109 to those used by consumers 102. Digital content vendors 108 interact with personal software and services 110 and devices 111 that relate to their premium digital content 112. Software and services 110 may comprise applications or services that are installed on a digital content vendor's 107 devices 111 or accessible through a network. Software and services 110 can include, but are not limited to: Google, Facebook, Apple, Dropbox, Crashplan, Carbonite, iPhoto, Aperture, Photoshop, Shutterfly, or any combination thereof. Devices 111 can include, but are not limited to: computers, smart phones, cameras, tablets, recorders, storage devices, or any combination thereof. A digital content vendor 108 can have premium digital content 112 that can be stored on devices 111 and managed with software and services 110. Premium digital content 112 can include, but is not limited to: image files, video files, and document files. These premium digital content 112 files can be referred to with file type terms that are commonly used by those of ordinary skill in the relevant arts, such as JPEG, RAW, PNG, MOV, WMV, MP4, and other terms. It will be understood by those of ordinary skill that those terms used herein are interchangeable, and any file type may be used.

The interactive content timeline platform 113 comprises personal digital content 106 from a consumer 102 and premium digital content 112 from a digital content vendor 108 that is managed through a user interface 114. Premium digital content 112 includes digital content that will have value to consumers 102 because the content was professionally produced by a digital content vendor 108. For example, a professional photographer may take family portraits that have value to a consumer 102 because the photographer has special training, professional equipment, and a studio that allows for the creation of different scenes for the photo based on backdrops and props. In another example, a premium content vendor 108 can have access to people they are photographing or videoing that a consumer 102 finds valuable because they don't have the ability or access to take the same photo or video. For example, sports played at large venues where photographers have access to the field and players while the fans are seated at a distance from anyone on the field or rink. In these cases, the digital content vendor 108 has the ability to capture pictures that consumers 102 can't. This creates premium digital content 112 that may be of value to certain consumers 102.

The interactive content timeline platform 113 also includes a digital content uploader 117 that is installed on consumer's 102 devices 105. The digital content uploader 117 has a user interface 114 that allows consumers 102 and digital content vendors 108 to select personal digital content 106 and premium digital content 112 that resides on their devices 105 and 111 and in their software and services 104 and 110 to the interactive content timeline platform 113.

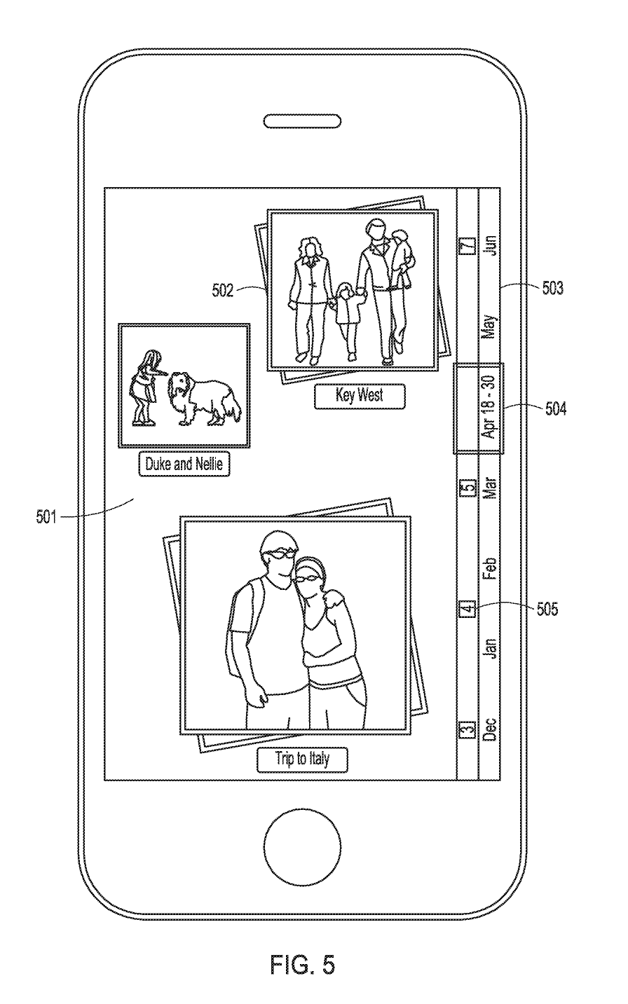

The interactive content timeline platform includes timelines 118. The user interface, functional attributes, and capabilities of timelines 118 are detailed more specifically in FIGS. 5, 6, and 7, described later. Timelines 118 comprises three types of timelines in one embodiment: private timelines 119, group timelines 120, and public timelines 121. Timelines 118 may render personal digital content 106 and premium digital content 112 using a user interface 114 displayed using dimensions of relative space between content based on time, size of a content container based on relevance to the consumer 102, and color related to the category of content. Private timelines 119 are specific to each consumer 102 and can only be accessed and viewed using the consumer's 102 specific account. For example, a consumer has a private timeline 119 where they create and/or curate and view their own content. In some embodiments, each timeline may be represented by a list of content with associated metadata, and an identification of an owner of the timeline, such as a user for a private timeline, or a group of people authorized to access the timeline. Authorization may also be made public, giving all users the ability to access the content associated with the timeline. Each story in the timeline may also be represented by a list of content, with one of the items of content being selected for representing the story in a view of the story in the timeline view. In further embodiments, a story may be identified via a query against available content, such as by date, time, location, or other fields of the metadata.

Group timelines 120 are limited to consumers 102 and/or digital content vendors 108 that were provided access or invited, typically using email or text message, to the group timeline 120 by another consumer 102 or digital content vendor 108. For example, a youth sports photographer that is a digital content vendor 8 may make a group timeline 120 available to the parents of a specific sports team.

Public timelines 121 are timelines that have been made available to the general public by a consumer 102 or digital content vendor 108. For example, a county government may make a series of records available to the public for viewing on a public timeline 121.

The interactive content timeline platform 113 includes a commerce platform 122. The commerce platform 122 allows digital content vendors 108 to publicize and sell premium digital content 112 to consumers 102 on timelines 118. The commerce platform 122 includes payment processing 123, which allows consumers 103 to purchase premium digital content 112 from digital content vendors 108. Payment processing capabilities include, but are not limited to: accepting and processing credit card transactions from consumers 102 and dispersing proceeds from the sale to the digital content vendor. The commerce platform 122 also includes a promotions manager 124 that allows digital content vendors 108 to develop and publicize promotions to consumers 102. Promotions that digital content vendors 108 create using the promotions manager 124 include, but are not limited to: coupons, special offers, direct discounts, free trials, ads, and other incentives publicized by the digital content vendor 108 to consumers 102. Promotions created with the promotions manager 124 are displayed in timelines 118 and viewable by consumers 102. Promotions can include “calls to action” that allow the users to click on the promotion in order to get more details on the promotion or take advantage of the incentives the promotion offers. The commerce platform 122 includes a premium digital content pricing manager 125 that allows digital content vendors 108 to set and manage prices for premium digital content 122 that they sell to consumers 102. The digital content pricing manager 125 includes, but is not limited to: the ability for digital content vendors to build multiple premium digital content 112 price lists, establish specific lists of premium digital content 112 associated with price lists, and assign prices to premium digital content in the price list. Using the digital content pricing manager 125, digital content vendors 108 can make specific premium content 112 with associated prices available to consumers 102 through timelines 118. Consumers 102 can then purchase premium digital content 112 for the prices and applied promotions associated with the digital premium content 112.

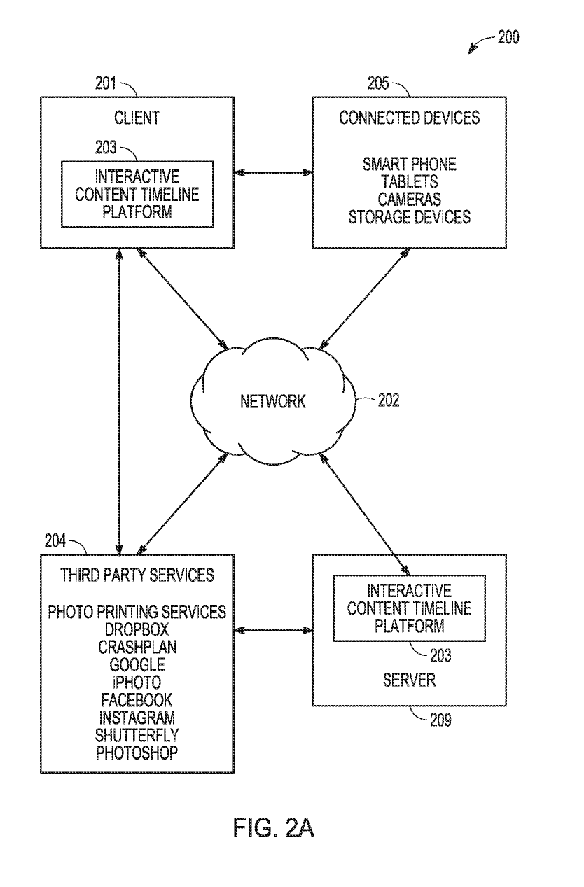

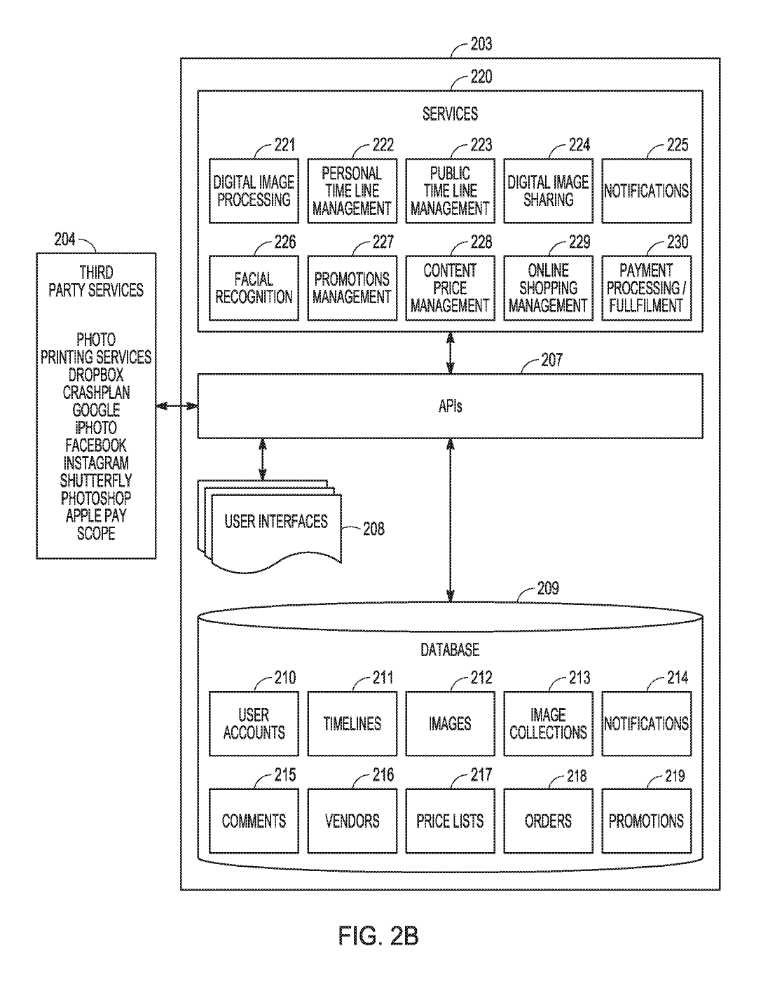

FIG. 2A is a block diagram of a system 200, which can include, but is not limited to: a client 201 and a 3rd party service 204 and connected devices 205 communicating with a server 209 over a network 202 utilizing a interactive content timeline platform 203. The network 202 may comprise of an Internet and/or intranet. The client 201 and server 209 may comprise a computer or mobile device. A computer may be any programmable machine capable of performing arithmetic and/or logical operations. In some embodiments, computers may comprise processors, memories, data storage devices, and/or other commonly known or novel components. These components may be connected physically or through network, bluetooth or wireless connections. Computers may be referred to with terms that are commonly used by those of ordinary skill in the relevant arts, such as servers, laptops, desktops, PCs, mobile devices, and other terms. It will be understood by those of ordinary skill that those terms used herein are interchangeable, and any computer capable of performing the described functions may be used. For example, though the term “server” may appear in the following specifications, the disclosed embodiments are not limited to servers. The 3rd party services 104 can include, but are not limited to: Google, Facebook, Apple, Dropbox, Crashplan, Carbonite, iPhoto, Photoshop, Shutterfly, or any combination thereof. Those of ordinary skill in the art will see that any service or application can be utilized as a 3rd party service. Connected devices 205 can include, but are not limited to, devices that connect to the client directly or through a network, such as smart phones, cameras, tablets, recorders, storage devices, or any combination thereof.

FIG. 2B sets forth system architecture details of the interactive content timeline platform 203, according to an embodiment. Services 220 may include, but is not limited to: digital image processing 221; personal timeline management 222; public timeline management 223; digital image sharing 224; notifications 225; facial recognition 226; promotions management 227; content price management 228; online shopping management; 229; and, payment processing and fulfillment 230. Services 220 are managed using APIs that translate requests between the user interface 208 and the database 209. The database 209 includes, but is not limited to: user accounts 210; timelines 211; images 212; image collections 213; notifications 214; comments 215; vendors 216; prices 217; orders 218; and, promotions 219. 3rd party services 204 can integrate with the interactive content timeline platform 203 using the APIs to communicate with the services 220 and database 209.

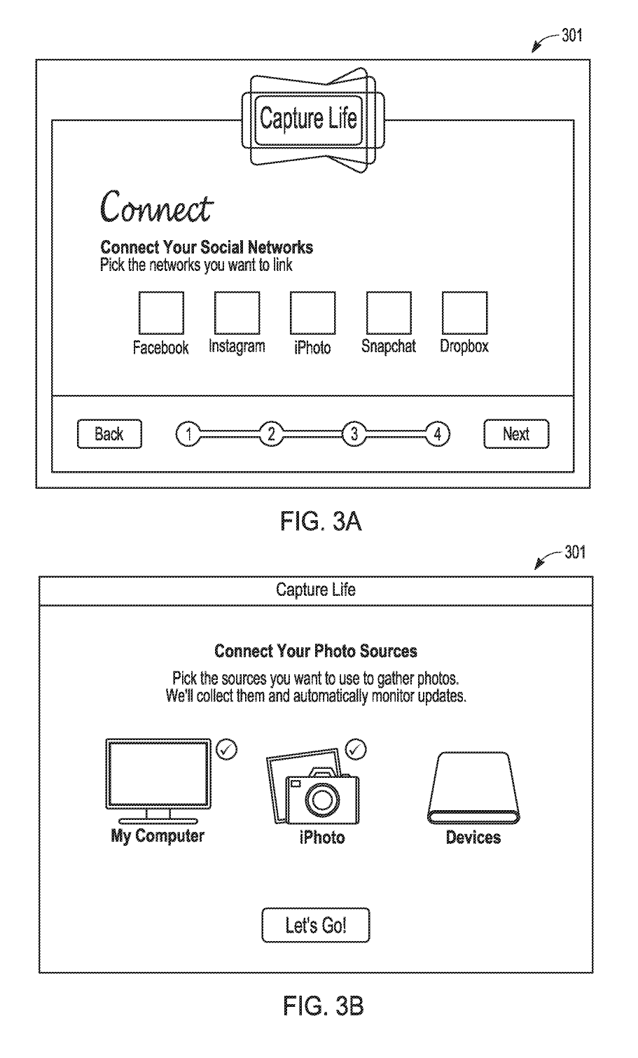

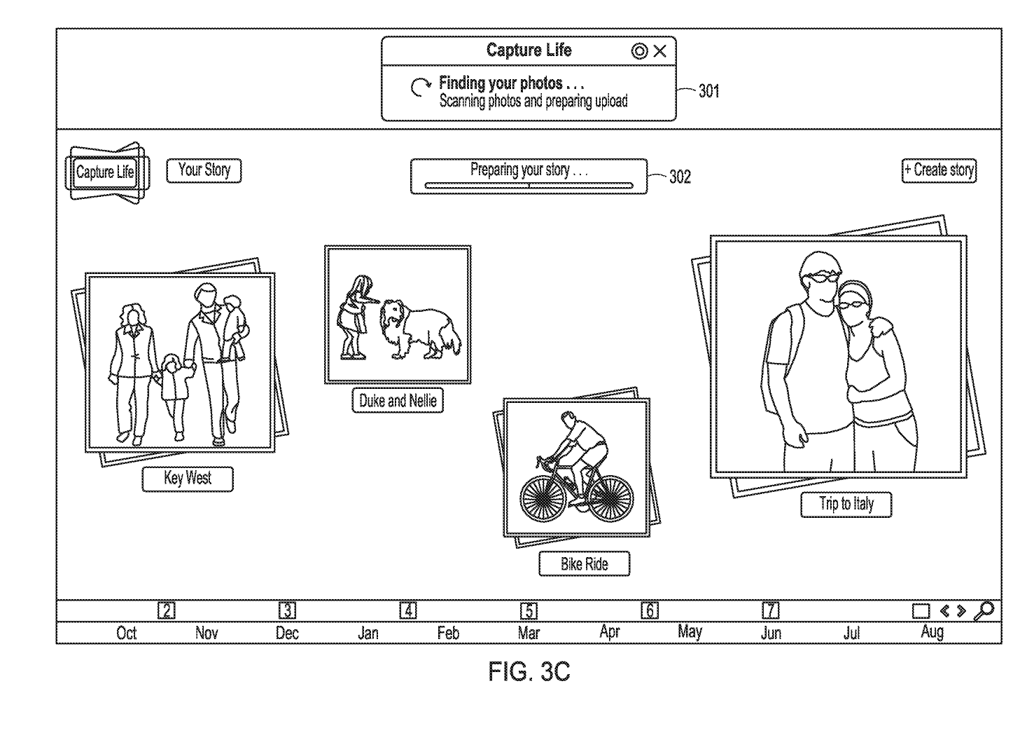

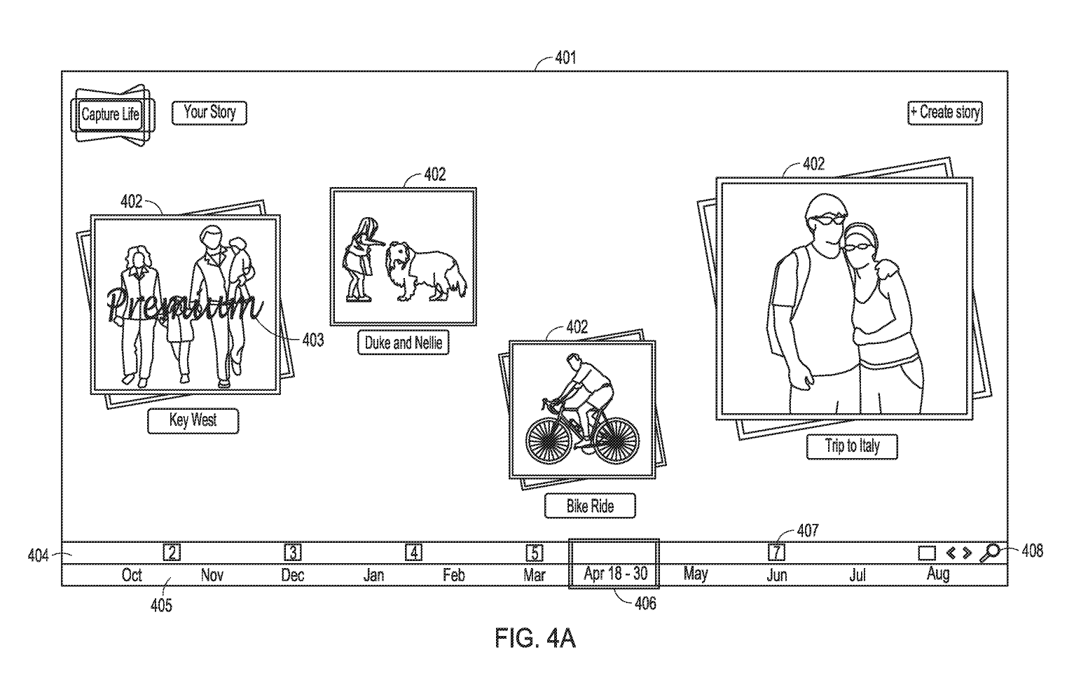

FIGS. 3A and 3B at 301 illustrates the user interface 114 previously described in FIG. 1 for the digital content uploader 117. The consumer 102 and digital content vendor 108 are guided through a process for selecting the content sources 103, 109 that they will connect to upload their personal digital content 106 and premium digital content 112 to the interactive content timeline platform 113. Interface 301 includes, but is not limited to, some of the options the user will be provided for connecting sources 103, 109 to the interactive content timeline platform. For example, if a consumer 102 is interesting in uploading the entire digital photo collection to the interactive digital content timeline platform 113 and their images are scattered across sources, like Facebook, Shutterfly, an external storage drive, Dropbox, and folders on their computer, they can select and connect to all of those sources and the digital content uploader 117 will copy the image files from all of those services and locations into the interactive content timeline platform 113 leveraging the APIs 207 to call the digital image processing 221 service, which creates the appropriate size images to store in the database 209.

FIG. 3C illustrates what the consumer 102 and digital content vendor 108 will see in the user interface 114 when the digital content uploader 117 is processing the content being uploaded to the interactive content timeline platform 113. A status indication 301 indicates that the uploader 117 is scanning content and preparing to upload content. Progress bars 302 are located in an operating system level indicating the overall status of the upload and for each piece of content in an illustrated timeline. Related content is represented by one of the pieces of content that is related.

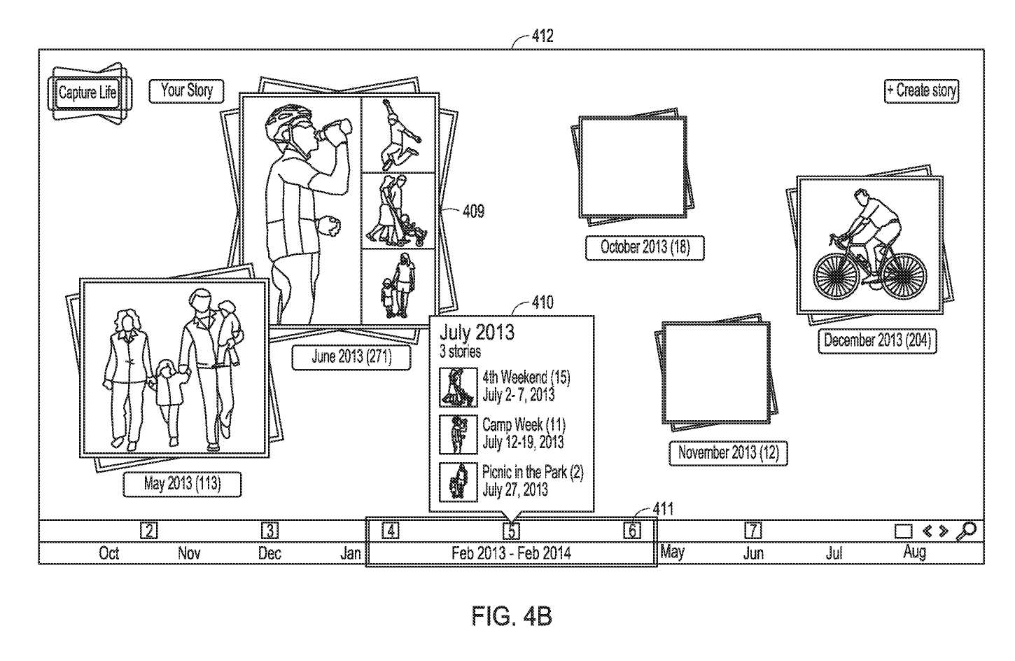

FIGS. 4A and 4B illustrate views of a main timeline 401 user interface for the interactive content timeline platform 113 with some of the associated elements. The timeline 401 view is what a user would see when using the interactive content timeline platform 113 from within an Internet browser. The timeline 401, includes, but is not limited to: stories 402; premium stories 403; time bar 404; timescale 405; time slider 406; story markers 407; and, zoom control 408.

The story 402 illustrates how content, such as digital images or videos, can be visually organized into stacks called stories based on the dates associated with the file's metadata. For example, if someone uploaded 10 pictures and 2 videos that were taken on the same date, they might appear together on the timeline 401. The size of the stack is calculated based on an algorithm that quantifies the consumer's 102 interest in that particular content. For example, the consumer might give more weight to content associated with vacations, holidays, or ones that include special people in their life. For such cases, the image representing the story 402 may be larger for content that is more meaningful to the user. A user in one embodiment may resize the image representing the story, which modifies the weight associated with the story. The stories 402 also dynamically render in size and space relative to the total amount of stories in the timeline.

Premium stories 403 illustrates an example of how premium digital content 112 and personal digital content 106 can exist within a consumer's 102 timeline 401. Premium stories 403 may include a special watermark indicating that there are one or more pieces of content in that story that have been published to the consumer's timeline 401 by a digital content vendor 108.

The timeline 401 includes a time bar 404 that comprises the navigational elements of the timeline. The timescale 405 indicates the ranges of dates/time for the timeline 402. The timescale 405 dynamically changes depending on the zoom control 408 level. The user can zoom out so that the timeline 401 shows a larger timeframe. For example, if the current timeline 401 view shows a two month time span, the user can zoom out with the zoom control 408 so that they can now see a one year time span in the active timeline 401 view.

Content (stories 402) also dynamically shift and render in the active view with any zoom level timeframe changes. The story markers 407 related to each of the stories 402 that are being displayed in the active timeline 401 view. Each story has a corresponding marker that is color coded based on story categories that can be set by the consumer. For example, stories that are categorized as “vacations” may have a different color than stories that have a category of “holidays”. Also note that the story marker's 407 vertical and horizontal location and spacing is directly relative to the way the corresponding stories are displayed on the timeline 401.

The time slider 406 frames the story markers 407 currently being rendered in the active timeline 401 view. The user can click and drag the time slider 406 from right to left to move the timeline 401 view forward and backward in time. As the time slider 406 moves forward and backward in time, the stories dynamically render based on which ones are reflected in the time slider 406 as it moves across time. The user can also drag the left and right edges of the time slider to expand the number of story markers 407 and related stories 402 are being displayed in the timeline 401.

FIG. 4B illustrates a timeline 412 in a state where the zoom control 408 has been zoomed out to show a broader timespan. When a user zooms out to increase the amount of time displayed on the timeline 401, stories 402 will consolidate based on their proximity in time, as shown in 409. For example, if a timeline 401 was zoomed into the point where you could see a story 402 for each day of a specific week, when you zoom out to increase the amount of time reflected in the timeline 401, those seven stories previously grouped by day could be consolidated into a single consolidated story 409 now grouped by week. The consolidated story 409 also illustrates thumbnails of the stories contained in that consolidated story 409 whereby the size of the thumbnails is based on the relevance of the content for that specific user. The story marker popup 410 demonstrates that when a user hovers their cursor over a consolidated story 409 marker, a popup showing the other stories in that consolidated view may be displayed. The consolidated story marker 411 displays the number of stories contained in a consolidated story 409.

FIG. 5 illustrates a view of the timeline 501 as it might appear on a mobile device, including, but not limited to smart phones and tablets. The timeline 501 includes, but is not limited to: stories 502; a timebar 503; time slider 504; and, story markers 505. The mobile timeline 501 view includes the dynamic rendering and interactions patterns described in FIGS. 4 and 4B in the previous section.

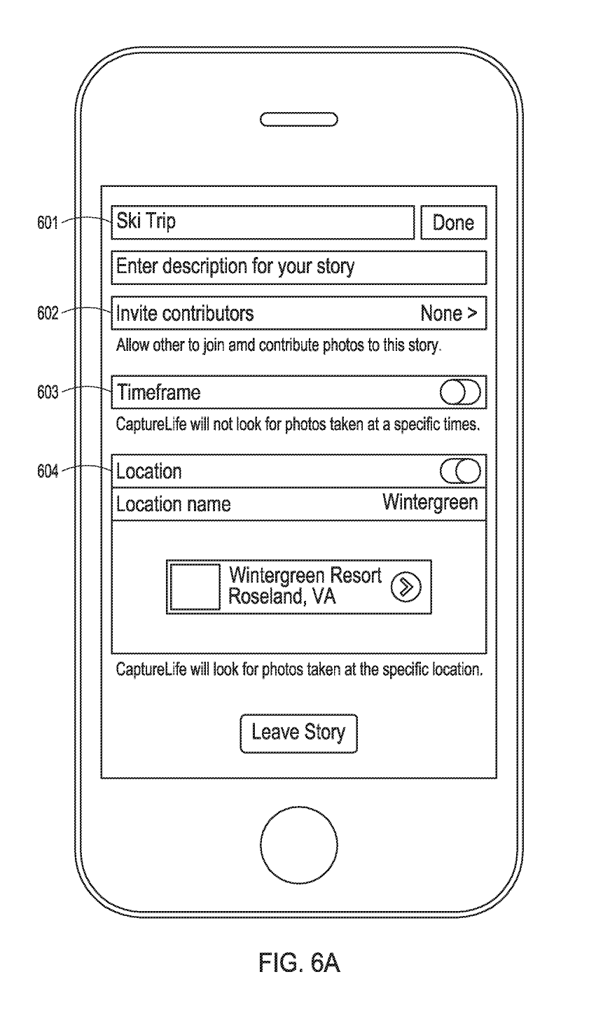

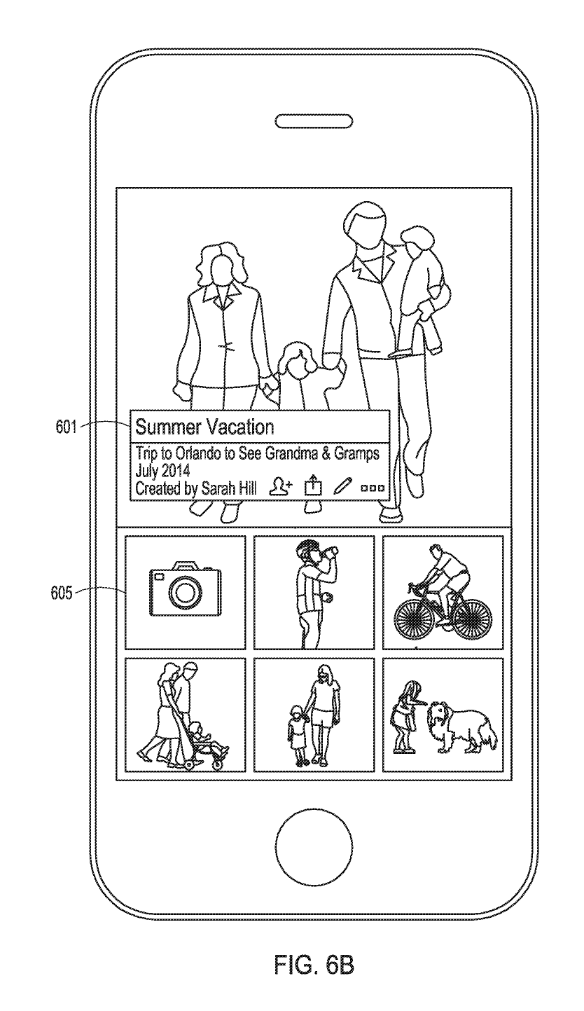

FIGS. 6A and 6B illustrate the creation of a story 601 that can be rendered on the timeline 501 and 401. Stories 601 and 402 can be created for events, such as family gatherings, vacations, birthdays, etc. There are no limits placed on users for what defines a story 601, 402. A story 601 includes, but is not limited to: contributors 602; timeframe 603; location 604, and, content 605.

When a user creates a story 601, they can invite other people (contributors 602) to privately join the story. When the contributors 602 option is selected, a list of contacts the user has stored on their device will be displayed. The user can choose to invite someone from the contact list or they can invite people by entering their email address or phone number. When the story 601 is created, the invited contributors are sent an email or text message invitation to the story 601. If they interact with the invitation and accept, they are now a contributor 602 on the story. This allows them to privately share content, such as, but not limited to, photos, videos, and files in the story 601 with other contributors 602.

The timeframe 603 option allows the story creator to set a timeframe for the story. For example, if a story 601 is created for a birthday party, the timeframe would be set to match the starting and ending date/time for the party. When a timeframe is set, if there is content 605 that matches the timeframe 603 for the story 601, the user will be prompted to share the content 605 in the story. For example, if a story 601 is set up for a birthday party and the user takes pictures and video (content 605) within the timeframe 603 set for the story 601, the user will be prompted to share those specific pictures and videos with other contributors 602 in that story 601. When content is shared in a story 601, all the contributors will see the content. Each contributor 603 can then determine which content they want to keep in their specific version of the story 601. For example, if five people at a party are contributors on a story that was created for that party, they may not want to keep all of the content 605 shared by those 5 people in their version of the story. They can select which pieces of content 605 they want to remove from the story 601.

A location 604 can be set for the story. When the location 604 option is selected, a map is displayed using the mapping capabilities of the device the user is using. The location defaults to the user's current location, however they can enter and search for another location. When a location 604 is set, there is a default circular radius set for the location 604. The default radius may be set to five miles, or any value desired compatible with the resolution of location identifying functions of a user device. The user can change that default radius to broaden or narrow the radius surrounding the location 604.

When a location 604 is set, if there is content 605 that has metadata with location coordinates that match the location for the story 601, the user will be prompted to share the content 605 in the story. For example, if a story 601 is setup for a family outing at a theme park and a location is set for the story matching the radius of the grounds of the theme park, and the user takes pictures and video (content 605) within the location 604 set for the story 601, the user will be prompted to share those specific pictures and videos with other contributors 602 in that story 601. In this scenario, if there are contributors 602 for the story that have content with metadata that matches the timeframe 603 set for the story 601 but the content 605 has metadata that does not match the location 603 for the story 601, the content will not be shared in the story.

For example, a mother creates a story 106 on her mobile phone and sets the timeframe 603 so it matches the timeframe when they will be at a theme park. She also sets a location that matches the coordinates and radius of the grounds for the theme park. She invites 3 contributors 602 to the theme park story she created. Two of the contributors will be at the theme park with her that day. The other contributor is her husband, who could not make the outing and is in another state on a business trip. In this case, if the father takes pictures or videos during the timeframe of the theme park story, his content will not be shared because it will have metadata that falls outside of the location set for the story.

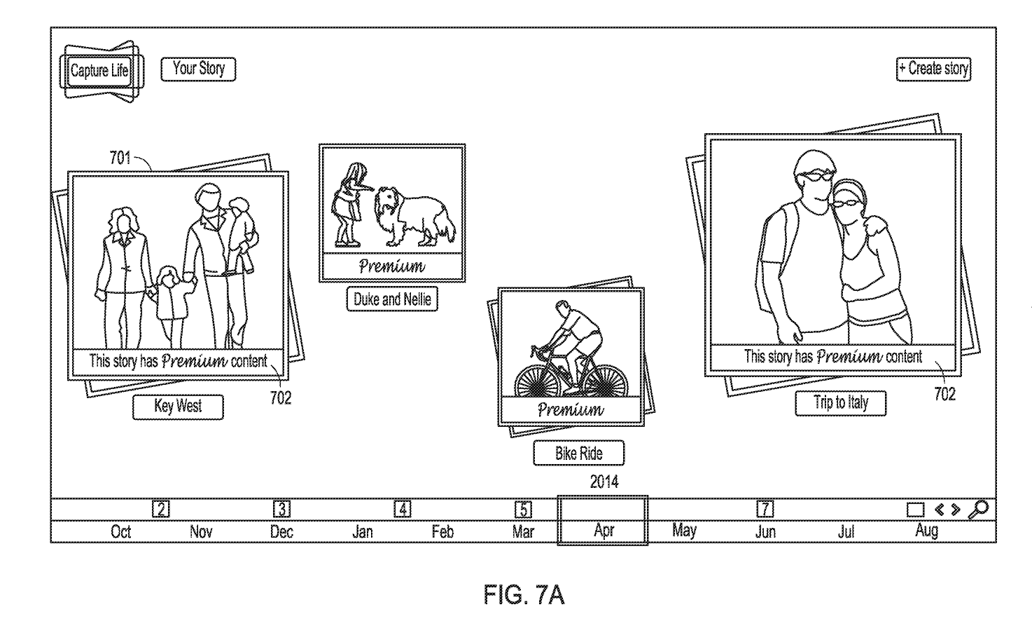

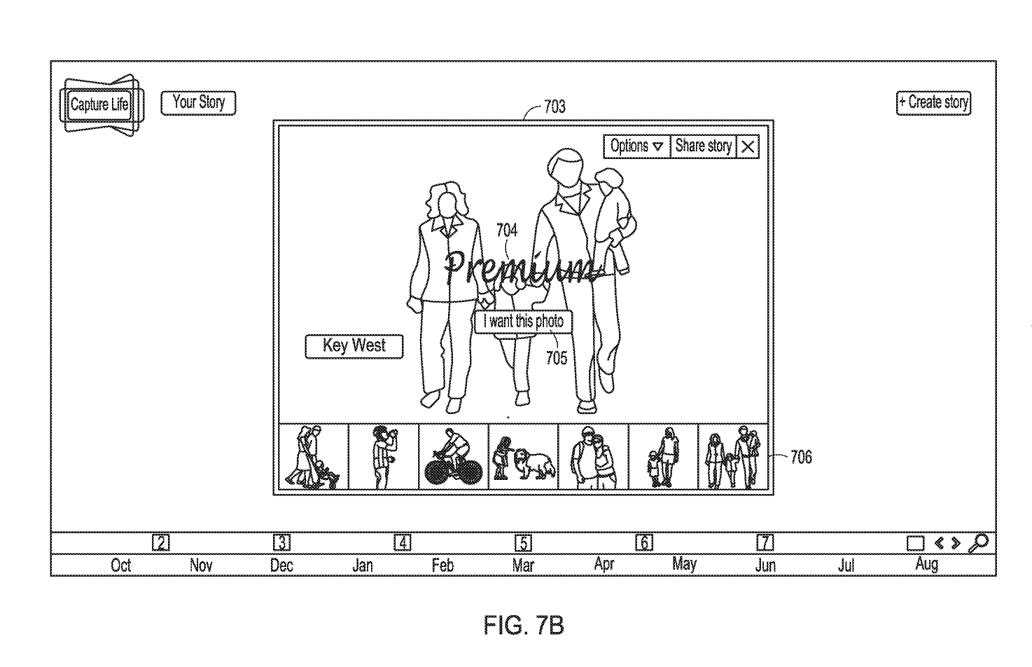

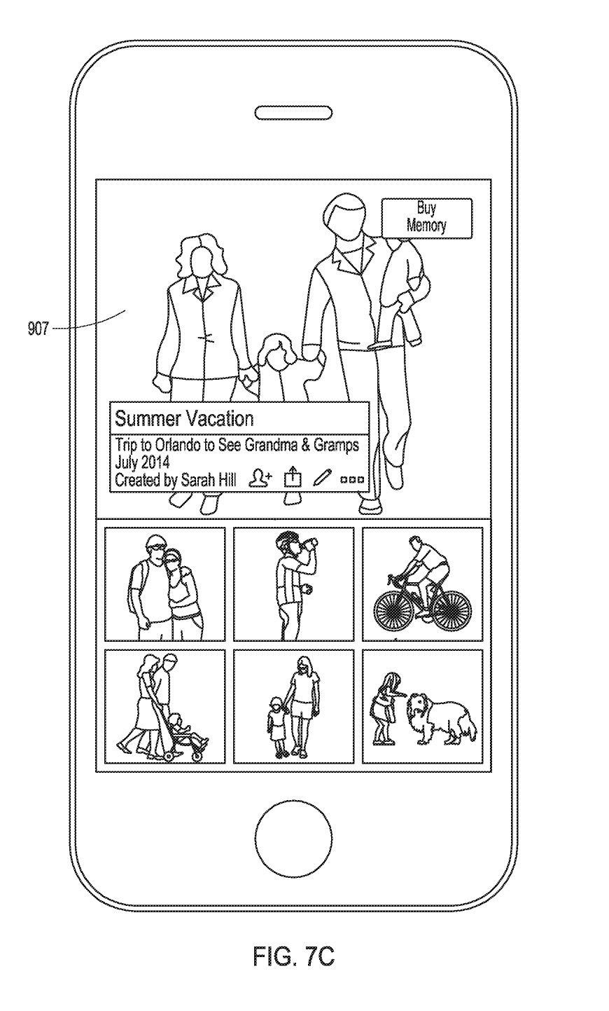

FIG. 7A illustrates a timeline 401 that includes premium digital content 112. Stories 402 that include one or more pieces of premium digital content 112 are considered premium stories 701 and have premium story watermarks 702 that inform users of the content. Timelines 118 can have a combination of personal digital content 106 and premium digital content 112.

FIGS. 7B and 7C illustrate a premium content story 701 that is opened by the user into the story viewer 703 on different devices, such as a tablet computer and mobile phone respectively. The story viewer 703 includes, but is not limited to, digital content thumbnails 706, which can be a combination of personal digital content 106 and premium digital content 112. If the story viewer 703 is displaying premium digital content 112, then a premium content story viewer watermark 704 is displayed over the content displayed in the story viewer 703. Premium digital content 112 can also include a purchase button 704 that allows the consumer 102 to purchase the premium content. The price associated with the premium digital content 112 is established by the digital content vendor 108 using the premium digital content pricing manager 125. When the purchase button 704 is clicked, the consumer 102 is presented with payment processing 123 options and the price of the premium digital content 112 they wish to purchase so that they can complete the credit card transaction.

For example, a person has a private timeline 119 that includes personal photos and videos, referred to as personal digital content 106, they uploaded from their computer. The person takes their family to a portrait studio such as digital content vendor, 108 to get professional pictures such as premium digital content 112, taken of their family. The portrait studio uploads the photos taken at the session to the person's private timeline 119. The portrait studio photos appear in a premium story 701 because it includes premium digital content. The user can browse through the photos using the story viewer 703 and purchase any photos they want using the purchase button 705. When premium digital content is purchased, the premium digital content watermark 704 is removed, indicating they are now free to enjoy, download, and print that content. The mobile user interface 907 of the interactive content timeline platform 113 includes, but is not limited to, all of the premium digital content 112 and purchasing capabilities described above.

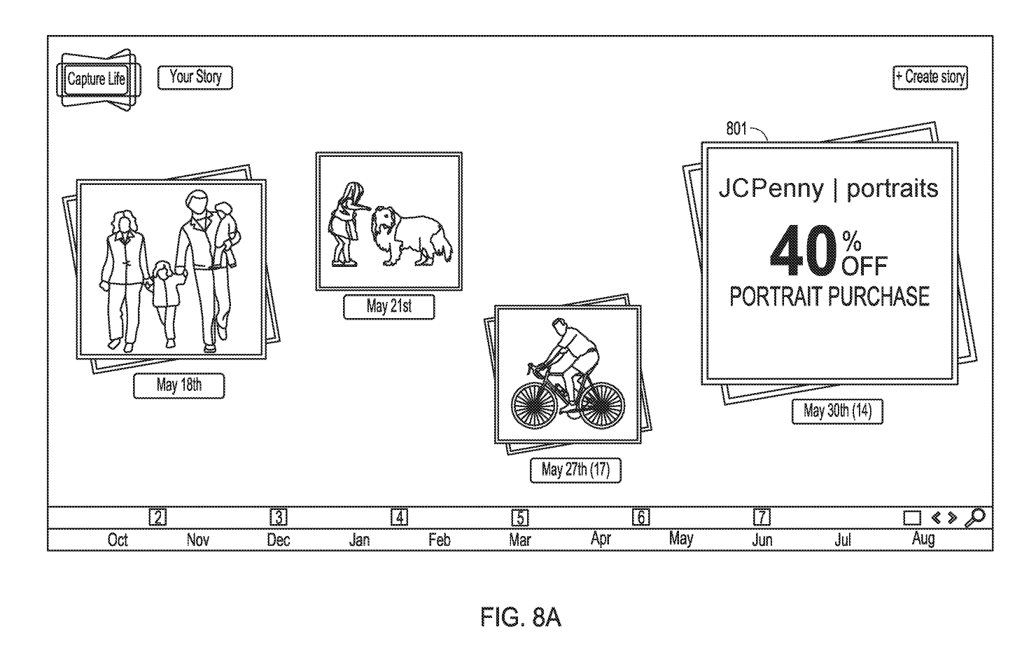

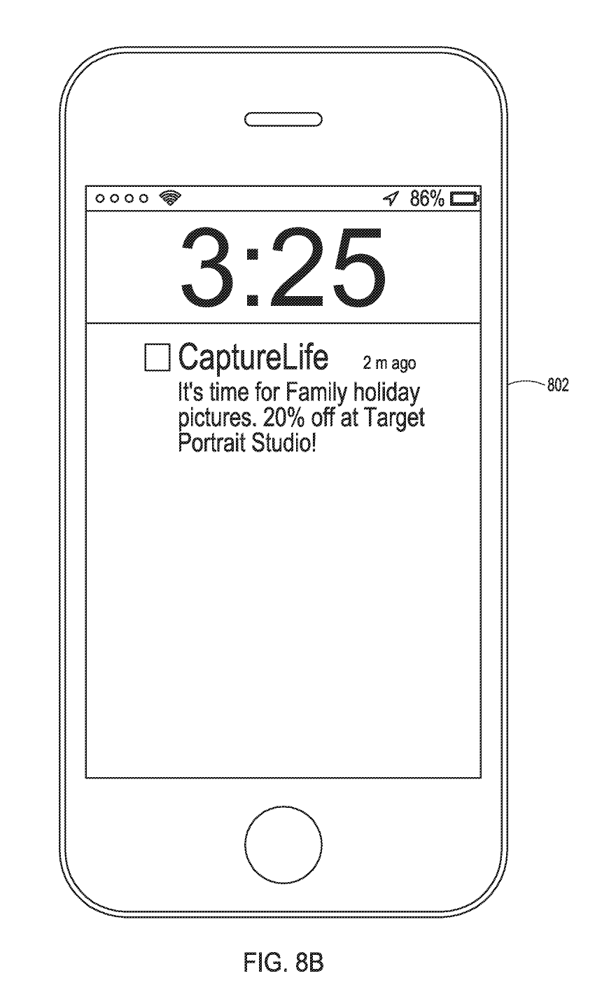

FIGS. 8A and 8B illustrate how promotions 801 can be published to a consumer's 102 timeline 118. Promotions 801 are created by the digital content vendor 108 using the promotions manager 124. Promotions can include “calls to action” that allow the users to click on the promotion in order to get more details on the promotion or take advantage of the incentives the promotion offers. Item 802 illustrates how consumers 102 can be notified on devices 105 when promotions are available.

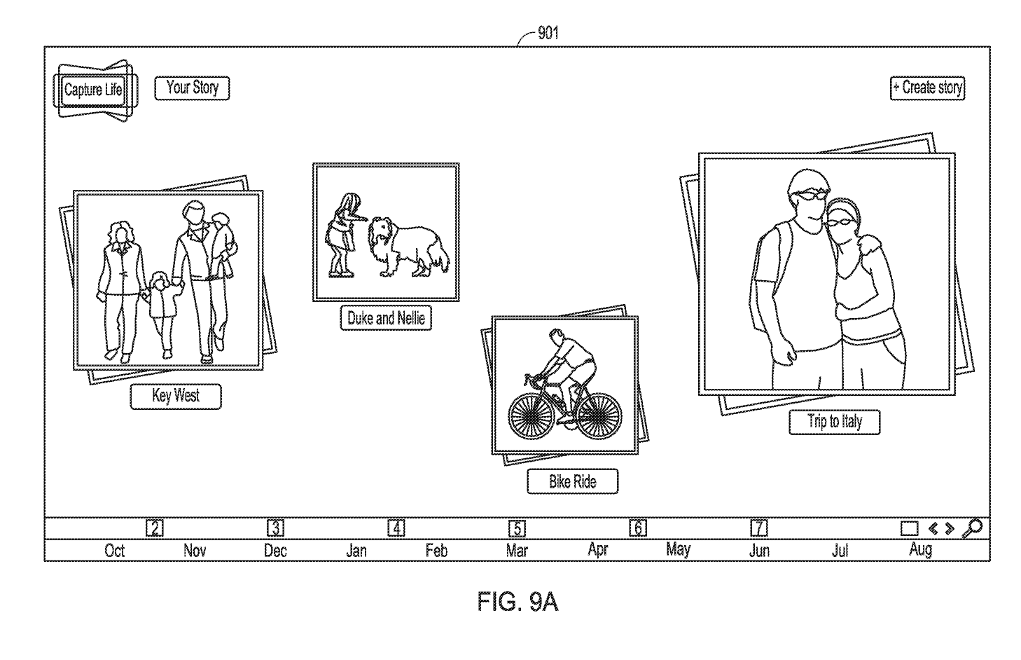

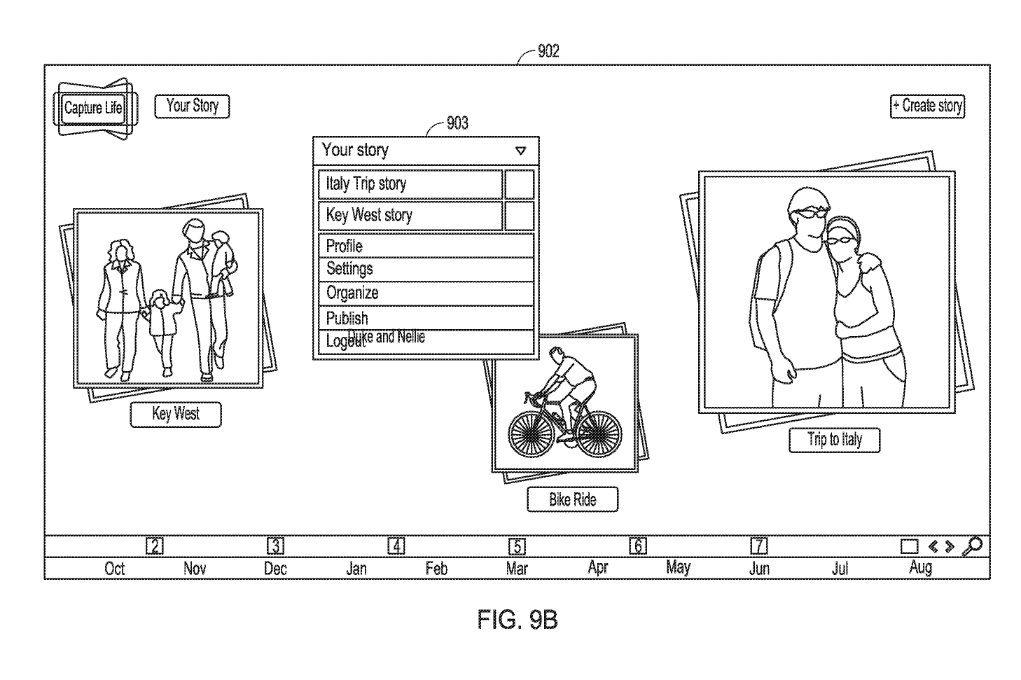

FIGS. 9A and 9B illustrate a public timeline 901 and 120 or group timeline 901, 121. Public and group timelines 901 typically include, but are not limited to, premium digital content 112 that is presented to a specific group of people or content that is open to the general public.

For example, a yearbook company (digital content vendor, 108 may want to create a group or public timeline 901 that includes pictures or videos of students taken by a high school yearbook staff throughout the school year and make the timeline available to the high school children's parents. Parents can then subscribe to the group or public timeline 801 from within their own personal timeline 902.

Item 903 of illustrates how users can see a list of group or public timelines for which they have been invited. Public or group timelines 901 can be accessed in different ways, including, but not limited to, invitations from the creator of the group or public timeline or through a list of public timelines that has been made available to the general public. Consumers 102 can browse public or group timelines and can either purchase (if the content is premium) to mark content to download to their personal timeline.

Users can also subscribe to a story line of a public or group timeline. A story line is a subset of stories on the group or public timeline that is categorized. For example, the parent of a high school student might subscribe to a storyline called “Soccer Team” so that they get notified when new content is added to that story line on the high school yearbook timeline.

One or more benefits of the interactive content timeline platform for consumers 102 may include:
1. Consumers have on platform where they can store and enjoy all of their digital content, including content they've purchased from professional digital content vendors.
2. A dynamic and new way for consumers to experience their digital content over time.
3. The ability for consumers to view their digital content by zooming in and out of time.
4. The ability for consumers to easily purchase digital content from digital content vendors from any device and have the purchased content be automatically added to their timeline.
5. Ability to be notified and take advantage of promotional opportunities from digital content vendors right from any device.
6. Ability to easily capture digital content, such as photos, from people at a private event. People using the platform will get pictures taken by others, which they would not have received otherwise.
7. Ability to easily and privately share digital content or an entire private timeline with family and friends.

Potential benefits for digital content vendors 108 may include one or more of:
1. A platform for traditional digital content vendors, such as photography companies, to transition from an exclusive printed delivery model to digital, which is what consumers are expecting.
2. Ability for vendors to use the interactive content timeline platform to publicize promotions to existing and potential customers to drive more business.
3. Method for content vendors to deliver a timeline of historical premium content to customers using the timeline.
4. Ability for vendors to drive digital subscription sales from consumers that want to upload and store all of their digital content in the interactive content timeline platform.

Ability to sell premium digital content to a group of consumers at a private event using the mobile application.

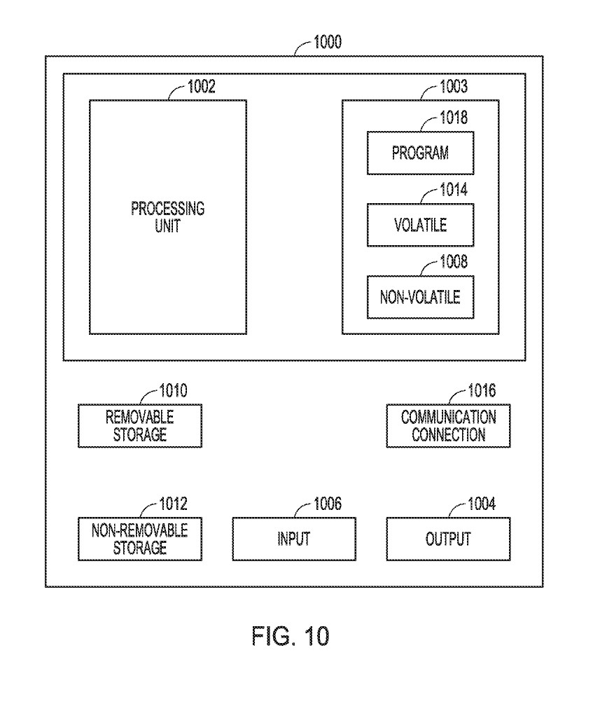

FIG. 10 is a block schematic diagram of a computer system 1000 to implement the various systems and devices that implement methods according to example embodiments. All components need not be used in various embodiments. One example computing device in the form of a computer 1000, may include a processing unit 1002, memory 1003, removable storage 1010, and non-removable storage 1012. Although the example computing device is illustrated and described as computer 1000, the computing device may be in different forms in different embodiments. For example, the computing device may instead be a smartphone, a tablet, smartwatch, or other computing device including the same or similar elements as illustrated and described with regard to FIG. 10. Devices such as smartphones, tablets, and smartwatches are generally collectively referred to as mobile devices. Further, although the various data storage elements are illustrated as part of the computer 1000, the storage may also or alternatively include cloud-based storage accessible via a network, such as the Internet.

Memory 1003 may include volatile memory 1014 and non-volatile memory 1008. Computer 1000 may include—or have access to a computing environment that includes—a variety of computer-readable media, such as volatile memory 1014 and non-volatile memory 1008, removable storage 1010 and non-removable storage 1012. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1000 may include or have access to a computing environment that includes input 1006, output 1004, and a communication connection 1016. Output 1004 may include a display device, such as a touchscreen, that also may serve as an input device. The input 1006 may include one or more of a touchscreen, touchpad, mouse, keyboard, camera, one or more device-specific buttons, one or more sensors integrated within or coupled via wired or wireless data connections to the computer 1000, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 1002 of the computer 1000. A hard drive, CD-ROM, and RAM are some examples of articles including a non-transitory computer-readable medium such as a storage device. The terms computer-readable medium and storage device do not include carrier waves. For example, a computer program 1018 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 1000 to provide generic access controls in a COM based computer network system having multiple users and servers.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A system comprising:
a database to store user personal digital content and timelines, the personal digital content having associated metadata that identifies a date and location of the content;
a communication mechanism to couple to third party sources of other digital content with associated metadata, and to the database associated with the timelines; and
a user interface mechanism to provide a timeline based view of the personal and other digital content, wherein the digital content is arranged in stories having a time represented by a view of at least one of the digital content in each story and dispersed along and positionally correlated to a user adjustable time scale of the view.

2. The system of claim 1 and further comprising a user interface construct to slide the time scale through time with corresponding stories repositioned in accordance with the time scale.

3. The system of claim 1 and further comprising a user interface construct to adjust a resolution of the time scale with corresponding stories repositioned in accordance with the resolution of the time scale.

4. The system of claim 1 and further comprising a browsing mechanism to facilitate inclusion of personal digital content and third party digital content in a story.

5. The system of claim 4 and further comprising a purchasing module coupled to the browsing mechanism to facilitate purchasing of such third party digital content.

6. The system of claim 1 wherein the user interface mechanism facilitates selection of color categories for identifying specific types of digital content.

7. The system of claim 1 wherein the timelines comprise private timelines for digital content specific to a user; group timelines for digital content corresponding to a specified group of users; and public timelines for digital content available to the general public.

8. The system of claim 1 wherein a size of the digital content representing a story is based on a weight given the story.

9. The system of claim 8 wherein the user interface mechanism is configured to facilitate resizing by the user of the view of the digital content representing a story and wherein resizing by the user changes the weight given the story.

10. A method comprising:
displaying a plurality of temporally identified stories comprising digital content on a display device, wherein the stories are spatially separated commensurate with a visible time scale;
receiving input from a user to manipulate the time scale; and
modifying the position and visibility of stories as represented by at least one image of the digital content of each story.

11. The method of claim 10 wherein each story is displayed as a view of one image of the digital content comprising the story.

12. The method of claim 11 wherein the image is sized as a function of a weight of the story.

13. The method of claim 12 wherein the image is resizable via the display and wherein the weight is changed responsive to resizing the image.

14. The method of claim 10 wherein content associated with each story is a function of time and location specified in metadata associated with each content item.

15. The method of claim 14 wherein the location is a function of a selected radius from a set of location coordinates.

16. The method of claim 10 and further comprising:
receiving an input to remove an image from a story; and
removing the image from the story responsive to the input.

17. A non-transitory computer readable storage device having instructions for execution by circuitry to perform operations, the operations comprising:
displaying a plurality of temporally identified stories comprising digital content on a display device, wherein the stories are spatially separated commensurate with a visible time scale;
receiving input from a user to manipulate the time scale; and
modifying the position and visibility of stories as represented by at least one image of the digital content of each story.

18. The non-transitory computer readable storage device of claim 17 wherein each story is displayed as a view of one image of the digital content comprising the story, wherein the image is sized as a function of a weight of the story, wherein the image is resizable via the display, and wherein the weight is changed responsive to resizing the image.

19. The non-transitory computer readable storage device of claim 17 wherein content associated with each story is a function of time and location specified in metadata associated with each content item, and wherein the location is a function of a selected radius from a set of location coordinates.

20. The non-transitory computer readable storage device of claim 17 wherein the operations further comprise:
receiving an input to remove an image from a story; and
removing the image from the story responsive to the input.
